(19) United States
(12) Patent Application Publication
(10) Pub. No.: US 2025/0348600 A1
(43) Pub. Date: Nov. 13, 2025

(54) HARDWARE ENFORCED DATA ISOLATION

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES); Gaspar Mora Porta, Castellon de la Plana (ES); Tommaso Vali, Sezze (IT); Satoru Tagaya, Barcelona (ES); Erich Ludwig Forcht, Stuttgart (DE); Akira Tsukamoto, Barcelona (ES)

(21) Appl. No.: 19/269,988

(22) Filed: Jul. 15, 2025

Related U.S. Application Data
(63) Continuation of application No. PCT/EP2025/060675, filed on Apr. 17, 2025.

(51) Int. Cl. G06F 21/60; G06F 21/31

(52) U.S. Cl. CPC G06F 21/602; G06F 21/31; G06F 21/604

(57) ABSTRACT

Aspects of enforcing data isolation with hardware are described. A hardware vault can receive a request to perform an operation on data. This request includes a credential and a reference to the data. The hardware vault can access a data structure for an indication that the operation is enabled for the data and read an encrypted form of the data from a location based on the reference from the request. The hardware vault can decrypt the data based on the credential from the request and then execute the operation on the data to produce a result which is written a writeback location.

### PRIORITY

This application is a continuation of International Application No. PCT/EP2025/060675, filed Apr. 17, 2025, which is incorporated by reference in its entirety.

### STATEMENT OF FUNDING

This invention was made with government support under Grant UNICO IPCEI-2023-001 funded by the European Union-Next Generation EU, Important Projects of Common European Interest (IPCEI).

### BACKGROUND

Computer data security often involves implementing measures to protect data from unauthorized access, alteration, or destruction while ensuring confidentiality, integrity, and availability. Security mechanisms can include encryption-which encodes data to prevent unauthorized reading—or access controls, which regulate user permissions based on authentication and authorization protocols. Secure storage solutions, such as hardware security modules (HSMs) or trusted platform modules (TPMs), provide cryptographic key management to protect sensitive information. Data integrity can be maintained using cryptographic hashing, checksums, or digital signatures to detect unauthorized modifications. Secure transmission protocols, such as Transport Layer Security (TLS) or end-to-end encryption, can be used to protect data in transit. Data loss prevention (DLP) strategies can include policies to restrict data movement or copying beyond authorized environments. Secure software development practices, such as regular security patching, secure coding standards, or vulnerability assessments, can be employed to mitigate risks associated with software-based threats. Compliance with regulatory frameworks, such as the General Data Protection Regulation (GDPR) or the Health Insurance Portability and Accountability Act (HIPAA), ensures adherence to legal and industry standards for data protection.

Data protection regulations, such as the GDPR or HIPAA, establish requirements for the collection, processing, storage, and transfer of user data to ensure privacy and security of users and their information. Compliance with these regulations often involves technical measures such as data minimization-which restricts data collection to only what is necessary for a specific purpose—or data anonymization or pseudonymization, which reduces the risk of re-identification by replacing personally identifiable information with non-sensitive identifiers. Encryption mechanisms, including Advanced Encryption Standard (AES) for stored data or Transport Layer Security (TLS) for transmitted data, can be employed to protect against unauthorized access. Access control frameworks-such as role-based access control (RBAC) or attribute-based access control (ABAC)—provide facilities to ensure that only authorized users can access specific data. Secure data storage solutions can incorporate audit logging and real-time monitoring to detect or respond to unauthorized access attempts. Additionally, data subject rights, such as the right to erasure (e.g., the right to be forgotten) and the right to data portability, often involve implementing structured data management systems that enable users to request data deletion or export in a machine-readable format. Compliance frameworks can also impose regular security assessments, vulnerability management, or incident response procedures to mitigate data breaches.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts a chiplet system with hardware enforced data isolation, according to an embodiment.

FIG. 2 depicts a processing flow for hardware enforced data isolation, according to an embodiment.

FIG. 3 depicts component interactions for hardware enforced data isolation, according to an embodiment.

FIG. 4 depicts an example of an architecture for hardware enforced data isolation, according to an embodiment.

FIG. 5 depicts a method for hardware enforced data isolation, according to an embodiment.

FIG. 6 depicts a hardware arrangement of a data center used to provide multiple implementations or instances of a computing system, according to an example.

FIGS. 7A and 7B depict arrangements of a chip assembly with expanded views of the chiplets and processing units, according to an example.

FIG. 8 depicts a block diagram of a computing system, according to an example.

### DETAILED DESCRIPTION

Ensuring that users (e.g., people) retain control (e.g., ownership or the right to erasure such as specified in the General Data Protection Regulation (GDPR)) over their data is an issue that arises in modern data-driven environments, such as artificial intelligence (AI) (e.g., in the democratization of AI). For example, current AI training environments lack mechanisms that enable data owners to specify which data segments can be accessed and processed by the underlying hardware constructs that perform data operations. As a result, once data leaves the control of its owner, enforcing restrictions on use of the data can become difficult (e.g., impossible), leading to a loss of data sovereignty. Users may wish to contribute their data to improve AI models that provide direct value in domains such as healthcare or automotive experiences while restricting other uses that may not align with their preferences or ethical considerations. However, there is no existing framework that enables this level of granular control, as current AI training infrastructures operate under a paradigm where data access decisions are enforced at the software level without hardware-enforced constraints. This absence of fine-grained control mechanisms creates a gap in AI governance, where users are forced to either withhold their data fully or relinquish control once it is shared, limiting both innovation and data privacy protections.

As noted above, systems or techniques currently available do not provide the level of control over data to enable users to share data for some uses and not others. Some current techniques enable limited encryption and security for data within a particular application, such as AI training, through memory encryption techniques like Total Memory Encryption (TME), Software Guard Extensions (SGX), and Transparent Data Encryption (TDE). These technologies provide protection for data during processing by ensuring that the data remains encrypted in memory, preventing unauthorized access from external threats or compromised system components. However, while these approaches secure the AI training model itself, they do not grant the data owner direct control over whether a specific data object can or cannot be accessed.

To address the issues with these simple data protection mechanisms (e.g., encrypting memory of a computer system), additional mechanisms such as confidential computing environments, policy-enforced access control, or decentralized identity frameworks can be used (e.g., integrated). Confidential computing, leveraging Trusted Execution Environments (TEEs), can help to ensure that data is not only encrypted in memory but also processed within a hardware-isolated enclave, preventing unauthorized access even by privileged system administrators. Attribute-Based Encryption (ABE) or Multi-Party Computation (MPC) can further enhance control by enabling data owners to specify access conditions based on cryptographic policies. Additionally, decentralized identity solutions using a blockchain or verifiable credentials can be used to help to enforce data access rights dynamically, ensuring that only authorized entities can interact with specific data objects based on predefined ownership policies. These techniques extend beyond traditional memory encryption if they are incorporated into a software stack and respected by a software developer. These last conditions, however, are often untrue and can change over the lifetime of service provider storing the data such that a once trustworthy company becomes less so due to changing market conditions or profit motives.

If a user hosts their data or provides their data only to a trusted host, the user may avoid the potential problems given above. That is, memory encryption or trusted execution environments merely prevent the interception of the data while it is being processed, but do not enable control over the data generally. Software vaults, such as those proposed in Tim Berners-Lee's Solid framework, enable individuals to grant or reject access to specific data objects, providing user-centric data control. These vaults function as secure data repositories where users can define fine-grained access policies for data consumers, including AI training services or analytics platforms.

Software vaults do have some issues. For example, when data is authorized for use by a data processor, there is no assurance that the data will not be copied or misused beyond the intended scope. Traditional access control mechanisms rely on software-based permissions, which do not inherently prevent unauthorized duplication once access is granted. Another issue of software vaults lies in the solely software-based mechanisms used. These mechanisms lack hardware-level enforcement and often fail to ensure secure data processing and control.

Addressing the issues noted above, a hardware and software co-design approach can be used. The hardware enforced data isolation (e.g., a hardware vault) described herein enables control over the data at the hardware level while enabling software to access an interface to interact with the data. Specifically, the interface enables the selection of an operation (e.g., a function, instruction, etc.) that is enabled by the user for specific data. Thus, when using a hardware vault, the software does not have access to the data itself, but merely the result of the approved operation executed against the approved data. This approach prevents the software from using the data for other, non-approved purposes while still enabling the user to share data as they see fit. Additional details and examples are provided below.

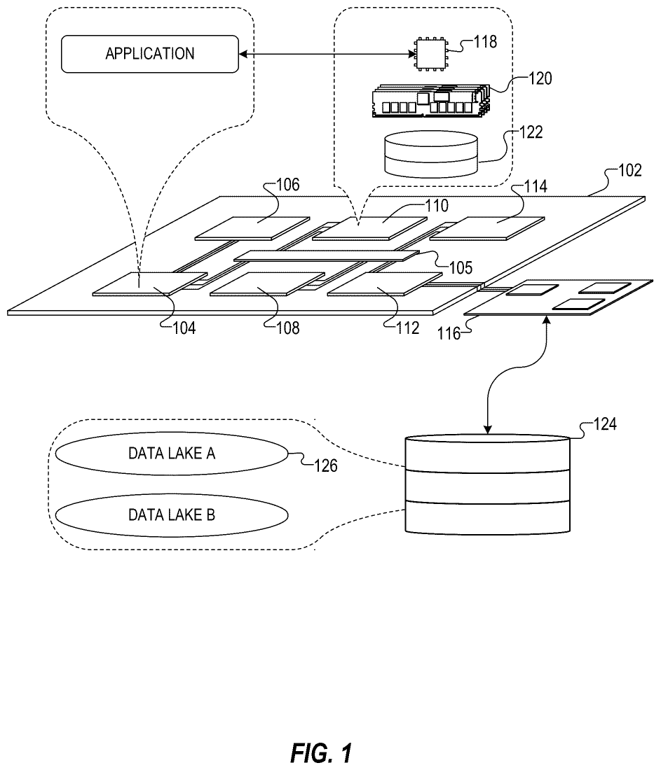

FIG. 1 depicts a chiplet system with hardware enforced data isolation, according to an embodiment. As illustrated, the operational and physical representation includes a chiplet system that can include a chiplet package 102 (e.g., an SoC, SiP, SoP, chiplet assembly, etc.) that includes a compute tile 104, memory 106 (e.g., random access memory (RAM)), a data movement accelerator 108, a hardware isolation facility like hardware vault 110 (e.g., a hardware vault device or a hardware secure vault), sensor processor 114, and an off-package interface 112 (e.g., a compute express link (CXL) interface). As illustrated, the compute tile 104 is directly connected to the memory 106—such as via a double data rate (DDR) memory interface, a High Bandwidth Memory (HBM) interface, Universal Memory Interface (UMI), or Bunch of Wires (BoW) interface, etc.—the off-package interface 112 is connected to an external component 116, such as a network interface, and the remaining components communicate via an input-output (IO) hub 105 (e.g., operating in accordance with a Universal Chiplet Interconnect Express (UCle) family of standards) of the chiplet package 102. The external component 116 can enable connectivity via a network to other systems, such as external storage 124 (e.g., remote storage), in a data center or in another arrangement via a variety of networking protocols, such as an IEEE 802.3 family of standards (e.g., Ethernet) or IEEE 802.11 family of standards (e.g., Wi-Fi) among others.

The hardware vault 110 includes processing circuitry 118, local memory 120 (e.g., RAM configured to maintain running state for the hardware vault), and local storage 122 (e.g., power-stable storage to maintain data between power cycles). The hardware vault 110 provides the interfaces and execution environment to implement the hardware enforced isolation described herein. Specifically, the processing circuitry 118 is configured to receive a request to perform an operation on data. As illustrated, the request originates from an application running on the compute tile 104 and is received via the IO hub 105. In addition to the requested operation, the request includes a credential and a reference to the data. In contrast to other data protection mechanisms mentioned above, this approach isolates the data from the application. That is, the application does not get direct control of the data. Rather, when the operation is authorized on the data and successful, the application only has access to the result of the operation on the data.

In an example, the request includes a writeback location. As is explained below, the writeback location specifies where the result of a successful operation will be written. Thus, by including the writeback location in the request, the application can provide some control over where the result will be written. As is also explained below, the writeback location can also specify additional input parameters to the operation. This approach can be useful when, for example, the result is a modification of current data (e.g., a current data structure) based on the operation and the data referenced in the request. A useful example of this scenario involves the training of AI models. Typically, the AI model will include data structures (e.g., one or more matrices) of weights representing neuronal connections. Training usually includes the updating of these weights given training data. Thus, the result can be an in-place update to the weights.

In an example, the request includes an application identifier. Generally, as explained below, the data is encrypted when stored to prevent unauthorized access. For example, the data stored in data lake A 126 of the external storage 124 is encrypted. When the application obtains (e.g., retrieves or receives) access to the data, part of this process can include receipt of a key to decrypt the data. Here, the key is an implicit authorization to the data. However, there can be circumstances in which additional conditions (e.g., restrictions) are desired. In these cases, the application identifier can be used to separately identify the application when applying these conditions as explained below.

In the example above, the decryption key can be granted to the application as its credential. However, the other forms of the credential can be used, such as a unique identifier, a passkey, a username and password, etc. In these cases, the processing circuitry 118 is configured to accept and to validate the credential. If the validation information is local to the hardware vault 110, such as stored in the local storage 122, then the processing circuitry) 118 is configured to locate the decryption key in response to a successful validation. In an example, the validating entity is external, such as a Trusted Authority service running across a network. In this case, the credential can be used to validate the access to the data object (or to receive service definitions of operation-data object enabled pairings) from the Trusted Authority service.

In an example, the reference is an address for the data. This address is contrasted with other identifiers of the data, such as a database key, slot location, hash key, a Uniform Resource Identifier, or the like. In an example, the address includes a memory address (e.g., a word, a range, etc. in byte-addressable memory). In an example, the address includes a storage address (e.g., a block, sector, slice, etc.). In an example, the address includes a chiplet address. In an example, the address includes a node address (e.g., a node address in a fabric, mesh, or other type of computer cluster). In an example, the address includes a network address (e.g., a Media Access Control (MAC) address, an Internet Protocol (IP) address, etc.). These different types of addresses can be combined to, for example, uniquely identify a memory or storage location in the chiplet package 102 or beyond.

In an example, the data is stored in the local storage 122 of the hardware vault 110. This example illustrates the ability of the hardware vault 110 to maintain the data locally. While such a scenario can be limited to the storage capabilities of the local storage 122, there are likely performance improvements to the proximity of the processing circuitry 118 and the local storage 122. Further, maintaining the data in the local storage 122 provides maximum control for extremely sensitive data.

In an example, the data is stored in the chiplet package 102 and external to the hardware vault 110. This example maintains the data in storage of the chiplet package 102, such as in flash storage or the like, the memory 106, etc. In an example, the data is stored external to the chiplet package 102. This is example is illustrated with respect to the data lakes (e.g., the data lake A 126) maintained in the external storage 124.

As illustrated, the hardware vault 110 is a chiplet in a chiplet system. However, the same principles can apply when the hardware vault 110 is a component (e.g., an expansion board or a separate package) in a computer system, or even when the hardware vault 110 is a standalone computer (e.g., server, blade, etc.). As illustrated, the request originates from another chiplet (the compute tile 104) in the chiplet system. Again, this is not a requirement as a request from another component in the computer system, or another computer altogether, would operate in a similar manner.

The processing circuitry 118 is configured to access a data structure for an indication that the operation is enabled for the data. The data structure can be a database, a list, a set of records, etc. In an example, the data structure can be stored in the local storage 122 and loaded into the local memory 120, for example, upon boot, at a reset, transition from a low-power setting to a high-power setting, etc.

The indication being sought by the processing circuitry 118 can take several forms. For example, the data reference can be a key to a list of enable operations. If the operation is in the list, then the operation is enabled, and disabled otherwise. Thus, the presence of the operation in the list is the indication. Conversely, the operation can be the key to a list of data references. In an example, the data structure can include a record for each data reference and each operation. The record can include the indication. This structure, while consuming more resources, can also enable more advanced conditions for operation enablement. These conditions could include time restrictions, location restrictions, etc. for a more powerful enablement (or explicit disablement) indication.

In an example, where the request includes an application identifier, the indication that the operation is valid (e.g., enabled, permitted, etc.) for the data is based on a permission in a second data structure that is located based on the application identifier. This example illustrates that multiple data structures can be used to maintain additional operation enablement indications. Here, a separate data structure is used to maintain application specific conditions applied to determine whether the operation is enabled for the data referenced in the request by the application. Thus, for example, while the operation can be enabled for the data generally, there can be a disablement specifically applied to the request application, for example, due to a security or other concern. Such application specific conditions can avoid the need to update keys and re-encrypt the data at all storage locations when, for example, a user disables access to the data for a specific application.

The combinations of operation, data, and possibly an application represented in the data structures above can be considered a service definition. Thus, in an example, the service definition includes an identifier of the data and a set of operations enabled for the data based on the identifier of the data. in an example, information from the service definition is used to populate the data structure. The installation of these service definitions can occur in different ways. For example, the hardware vault 110 can be configured with the service definitions when it is manufactured or installed in the chiplet package 102. In an example, a controller chiplet, such as the compute tile 104, can install the service definitions as part of a boot, reset, or other setup sequence.

In an example, the processing circuitry 118 is configured to receive a service definition from a trusted service external to the hardware vault 110. Here, the trusted service can be hosted by another chiplet of the chiplet package 102, or an external component (e.g., an expansion board in a computer system that includes the chiplet package 102 or another computer system altogether). In an example, the trusted service is implemented with a trusted execution environment (TEE) in the chiplet package 102.

In an example, the processing circuitry 118 is configured to communicate with the trusted service in response to receiving the request. This type of “on-demand” service definition loading can simplify management of service definitions at the hardware vault at the cost of some latency the first time that the request is made. In an example, the processing circuitry 118 is configured to communicate with the trusted service based on a periodic basis or upon a trigger, such as an initialization sequence upon first being powered up, upon a diagnostic interrupt or command, or other similar event experienced by the hardware vault 110.

As noted above, the data is generally encrypted when stored. Thus, the processing circuitry 118 is configured to read an encrypted form of the data from a location based on the reference. As previously described, the reference to the data can be an address or another identifier that enables the data to be located (e.g., a database key for a record that includes the data or an address to the data). Accordingly, in an example, the location is in a second data structure that maps the reference to the location. Here, the processing circuitry 118 is configured to query the second data structure using the reference to obtain the location.

The processing circuitry 118 is configured to decrypt the data from the encrypted form. Decryption is generally required unless the operation can operate on the encrypted data. However, for most operations, the data is decrypted before it can be used in the operation. Because the decryption occurs within the confines of the hardware vault 110, the unencrypted data is not exposed to other processes or hardware, ensuring that the data remains secure. In an example, the encrypted data can be loaded into the local memory 120 for processing in the operation. In an example, the data is not stored in an unencrypted form in the local storage 122.

The processing circuitry 118 is configured to execute (e.g., run, perform, etc.) the operation on the data to produce a result. Thus, in this example, the performance of instructions against the data itself is all contained within the hardware vault 110 and an encrypted form of the data or the result of the operation on the data are the only things that the application, or any other hardware, can access. This isolation effectively prohibits the type of raw data copying possible with software vaults or the other techniques mentioned above.

In an example, wherein the request includes a writeback location, to execute the operation, the processing circuitry 118 is configured to retrieve second data from the writeback location and to use the second data as a parameter to the operation. In an example, the result is a modification of the second data. As noted above, this type of interaction can be used to update the data in the writeback location. For example, if the operation is adding the user's demographic data to a running tally, the operation can perform a count on the user's data and add the result to the tally. Other instances of this type of activity can include neural network training. Thus, in an example, the second data is a portion of a neural network. In an example, the operation is a training operation for the neural network. In an example, the result is an update to the portion of the neural network. Such an arrangement enables a wide variety of structures or data accumulations to incorporate information about the user from the data without, for example, exposing the user's identity unless the user enables such disclosure.

The processing circuitry 118 is configured to write the result to a writeback location. In the update examples described above, the writeback location is specified in the request. Even if the request is not for an update of existing data, the request can include the writeback location as, for example, a memory address for a remote function return in an execution stack of the application. This may be a typical way to incorporate the result into the standard processing pipeline of the application. In an example, writing the result includes transmitting the result via the interface. In an example, the interface conforms to a Compute Express Link (CXL) family of standards. In these examples, if the writeback location is not provided in the request, a standard writeback location, such as in the memory 106 can be used. In an example, writing the result to the writeback location includes writing the result to a set of output registers of the hardware vault 110. Here, the writeback location are registers that can be read by the application, or the compute tile 104, as can be the case when interacting with other hardware interfaces. In an example, wherein the result is encrypted with the key before writing to the writeback location is complete. This example ensures that the data remains encrypted when it is external to the hardware vault 110.

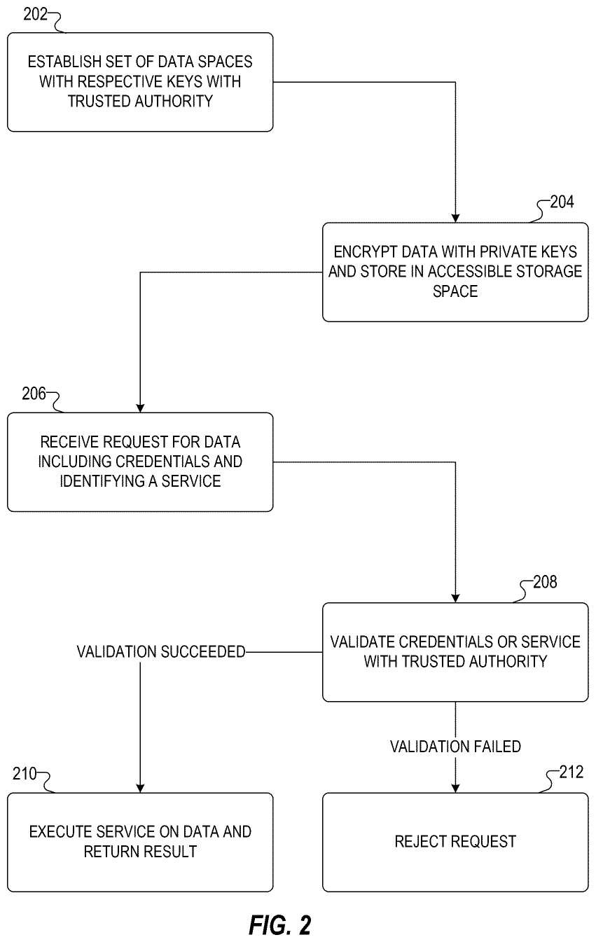

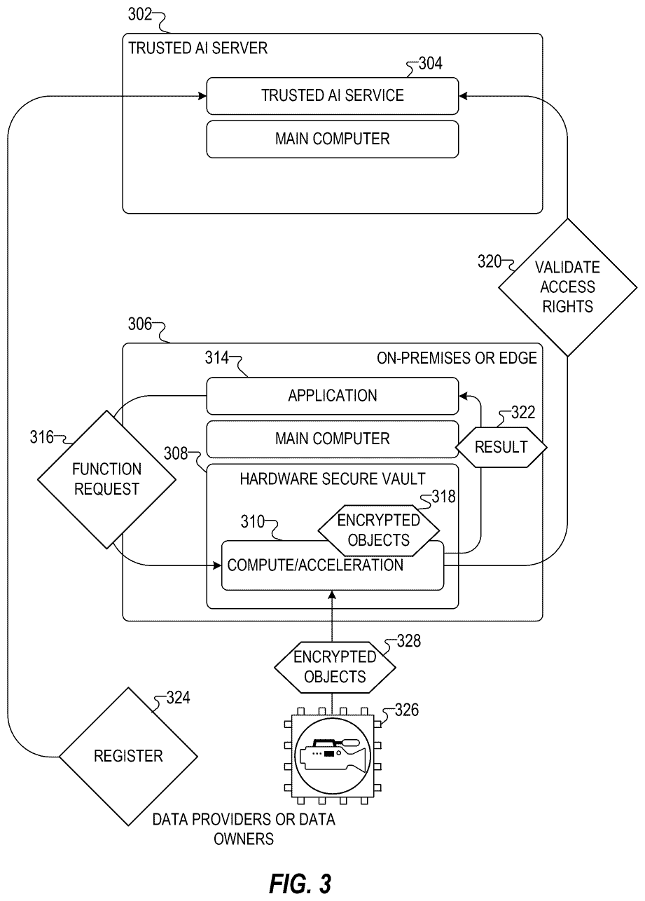

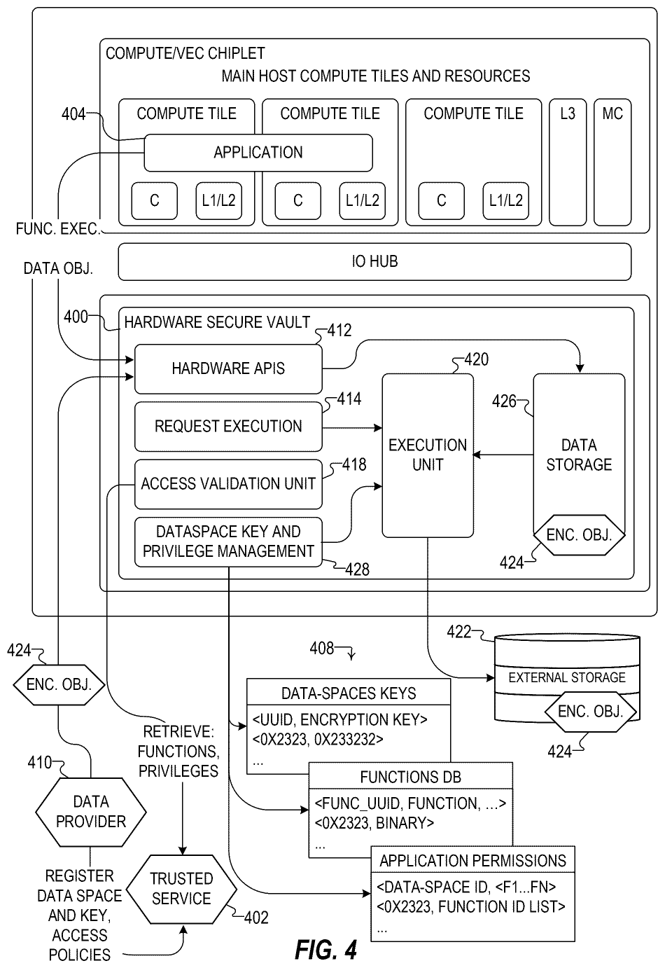

FIG. 2 depicts a processing flow for hardware enforced data isolation, according to an embodiment. The illustrated flow can operate with the components, devices, systems, or architectures described above or below and enables a new way to process data objects owned by users in a manner that enables the users to retain control over the data object, that control including the ability to grant or deny access to the data object at any time. The flow assumes a hardware isolation facility, such as the hardware vault 110 illustrated in FIG. 1, the hardware secure vault 308 illustrated in FIG. 3, or the hardware secure vault 400 illustrated in FIG. 4. In general, the hardware isolation facility is trusted by the Trusted Infrastructure and enables services or applications to access a user data object and to perform certain types of operations without having direct access to the data itself.

In an example, the hardware isolation facility can include a set of predefined functions that will provide a result to the software stack after being executed against them with the data object. In general, the functions designed—and, for example, verified by an auditing service—to limit or reduce the amount of information from the user data object that is provided to the software stack because of the execution of the function.

With the hardware isolation facility, and a catalog of defined functions, the general flow of interaction can proceed as illustrated. The general flow of interaction comprises two parts that may take place independently from each other. In a part, which relates to, e.g., organization, storage, access management of data. For example, data owners (e.g., users) can define data spaces to organize their data (operation 202). In an example, each data space can have a private key used to secure the data in the data space (e.g., a data lake) wherever the data is stored (operation 204). Thus, these data spaces can be considered a logical division of the data rather than necessarily being stored in a single filesystem, drive, or the like. Data owners can decide what consumers (e.g., applications, services, etc.) can access the data objects that are stored in a particular data space, and what functions can be executed by each one of those consumers. In an example, these choices can be registered with a Trusted Authority to maintain these configurations.

Another part relates to, e.g., access and/or use of data, e.g. provided by the foregoing part. When a software stack attempts to access a particular data object using a specific function, the software stack requests the hardware isolation facility to do so, forwarding the credentials (e.g., the key for the data space) that the software stack has been granted by the user, possible via the Trusted Authority (operation 206). In an example, instead of the key itself, the credentials can include a code, a username and password, or other identifier that the Trusted Authority can use to retrieve the key.

The hardware isolation facility can then validate with the Trusted Authority for an access configuration of the software stack (e.g., the data key, enabled operations, operations enabled for specific data, or other conditions) (operation 208). For example, the validation may include providing a accessing a data structure for an indication that the operation is enabled for the data. If the validation succeeds, for example, the key decrypts the data or the combination of operation and data are enabled, the hardware isolation facility performs the operation (operation 210). Otherwise, the request is rejected (operation 212). In an example, the Trusted Authority can authenticate with the hardware isolation facility before sending the acknowledgement and the private key to access the data and perform the operation.

FIG. 3 depicts component interactions for hardware enforced data isolation, according to an embodiment. In the illustrated architecture for enabling access to user data objects used to train an AI model or component, a Trusted AI Server 302 is hosted in a trusted infrastructure. The Trusted AI Server 302 can take different forms, such as a remote datacenter hosted (e.g., cloud) service, to a standalone server, to a virtual service accessible by the node 306. This Trusted AI Server 302 exposes APIs 304 to the data provider 326 to register their data spaces and the corresponding private keys associated to them (activity 324). It is not necessary that every data provider needs to directly interact with the APIs 304. In an example, the functionality of the APIs 304 can be offered by a software stack that provides easy access to those APIs 304. In general, the APIs 304 enable defining access or process rules for the data objects that are, or will be, stored. As Illustrated “main computer” for either node encompasses a processor, memory, or other processing components executing elements of the node.

The data provider 326 generates a data object and secures the data object, for example using a private key, to create the encrypted objects 328. Often, data objects will be stored in various media (e.g., storage, memory, etc.) and various locations (e.g., cloud, edge, fog, on-premises, etc.). Accordingly, a data space can be considered to be a data lake that is distributed across these storage media.

At a node 306, an application 314 (e.g., a service) is restricted to request (activity 316) performance of a catalog of functions defined for a particular data object via the hardware secure vault 308 (e.g., trusted hardware vault). The hardware secure vault 308 includes a compute unit 310 that has access to the encrypted data objects 318. Although the illustrated example maintains the encrypted objects 318 within the hardware secure vault 308, in an example, the encrypted objects 318 can be stored elsewhere (e.g., such as main memory for the main computer) and read by the hardware secure vault 308 to ensure appropriate access controls. The hardware secure vault 308 is configured to validate the credential(s) provided in the request (activity 316) with the Trusted AI Server 302 (activity 320). If this validation passes, the hardware secure vault 308 is configured to execute the function and return the result 322 to the application 314. Part of the validation can include obtaining a key to decrypt the encrypted data objects 318 to enable performance of the function.

FIG. 4 depicts an example of an architecture for hardware enforced data isolation, according to an embodiment. In the illustrated architecture, the hardware secure vault 400 includes several sub-components (e.g., discrete processing circuitries within the hardware secure vault). In an example, the hardware secure vault 400 can include cryptographic blocks (e.g., discrete sub circuitries) configured to accelerate cryptographic tasks such as encryption, decryption, key management, etc. These sub-components can include a set of interfaces 412 (e.g., the hardware APIs), request execution circuitry 414, access validation circuitry 418, dataspace key and privileges management circuitry 428, an execution unit 420 (e.g., a processor, set of abstract execution units (ALUs), etc.), and data storage 426. Although the hardware secure vault 400 is illustrated as a chiplet, the hardware secure vault 400 can be implemented as an expansion card (e.g., a CXL-attached device), separate package, or standalone server (separate computer, system element, or system that provides resources, data, services, or programs to other devices over a network).

The set of interfaces 412 provides external access to the hardware secure vault 400, enabling, for example, the application 404 to make a request, or for a data provider 410 to provide the encrypted object 424 to the hardware secure vault 400 (e.g., to be held in the data storage 426).

The request execution circuitry 414 is configured to coordinate performance of the function (e.g., to execute the function), using the data object (e.g., encrypted in the encrypted object 424) on the execution unit 420. Thus, the request execution circuitry 414 can operate as a type of scheduler or loader to prepare the function for execution by the execution unit 420 on the data (e.g., the encrypted object 424) retrieved from the data storage 426.

The access validation circuitry 418 is configured to interact with the trusted service 402 to retrieve service definitions. The access validation circuitry 418 can be configured to validate credentials from the request from the application 404, or otherwise determine that the application 404 application or service (e.g., with a specific Universally Unique Identifier (UUID) and certificate, or other credential) has access to the encrypted object 424 and the function or functions to be applied to the data in the encrypted object 424.

The dataspace key and privileges management circuitry 428 is configured to manage or to cache definitions 408 or data spaces, application permissions, or functions. Thus, the dataspace key and privileges management circuitry 428 can provide, for example, function code to the execution unit 420, keys to the data space, whether hosted in the data storage 426 or at external storage 422, or provide conditional restrictions on the function execution based on the application. For example, the execution unit 420 can be configured to apply stochastic noise to enhance differential privacy or other conditions that can be directed by the definitions 408.

Functions-which can be stored locally (e.g., in the data storage 426 or in the dataspace key and privileges management circuitry 428 or retrieved from an external entity (e.g., another chiplet, the trusted service 402, etc.)—are not visible to the application 404 running outside of the trusted domain. In an example, functions can have access to structures provided by the application 404 to store a result of the function or to data that will be modified by the application of the function to the data in the encrypted object 424. For example, a function could implement neural network training (e.g., including backpropagation) using the data in the encrypted object 424 and can update the weights of the neural network referenced by the application 404 in a pointer provided as part of the function request by the application 404. This is an example of one or more parameters that can be provided to the function prior to execution. Examples of these application provided parameters can include pointers to application data structures (e.g., format pre-established); parameters to the function itself; pointer to data space or a list of objects, among others.

In an example, a directory component is configured to provide discovery services to the application 404 or other services. The directory component can include discovery of datasets, data objects (whether stored locally in the data storage 426 or remotely in the external storage 422), or functions that are accessible to the application 404. In an example, dataspaces or data objects can be tagged (e.g., marked, associated with, etc.) with metadata identifiers to obfuscate private information of the data owner while still enabling a decision as to whether or not to use the data. For example, a data object can be a healthcare radiology image with a result of analysis by a physician, but the data object omits information about who is providing such data.

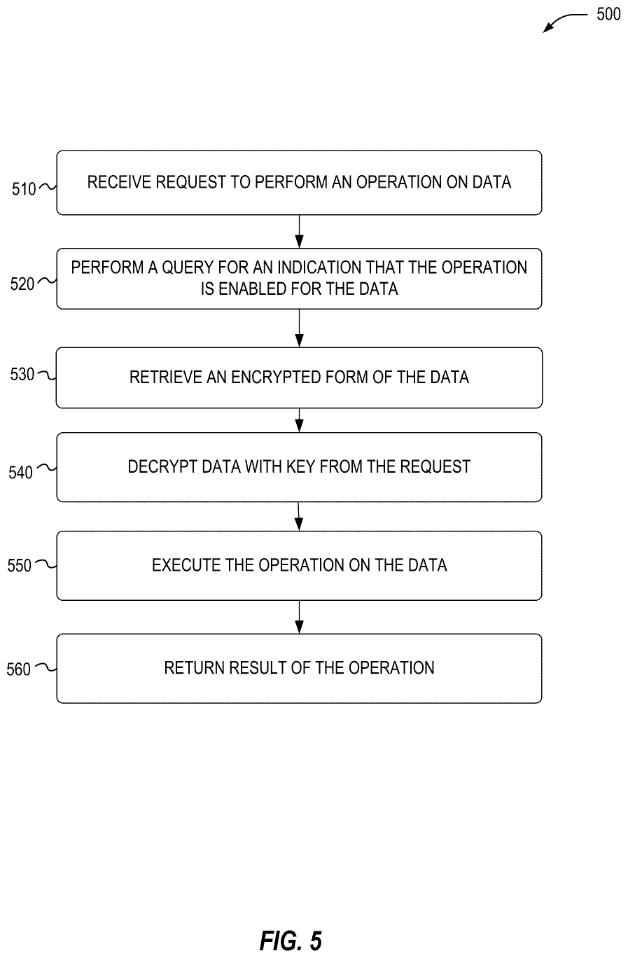

FIG. 5 depicts a method 500 for hardware enforced data isolation, according to an embodiment. The operations of the method 500 are performed by computational hardware, such as that described above or below (e.g., processing circuitry).

At operation 510, a request to perform an operation on data is received (e.g., at an interface of a hardware vault device). This request includes a key and a reference to the data. In an example, the request includes a writeback location. In an example, the request includes an application identifier. In an example, the reference is an address for the data. In an example, the data is stored in storage of the hardware vault device.

In an example, the hardware vault device is a chiplet in a chiplet system. In an example, the request originates from another chiplet in the chiplet system. In an example, the data is stored in the chiplet system and external to the hardware vault device. In an example, the data is stored external to the chiplet system.

At operation 520, a data structure is accessed (e.g., by processing circuitry of the hardware vault device) for an indication that the operation is enabled for the data. In an example, where the request includes an application identifier, the indication that the operation is enabled for the data is based on a permission in a second data structure that is located based on the application identifier.

In an example, the operations of the method 500 further include receiving a service definition from a trusted service external to the hardware vault device. In an example, the service definition includes an identifier of the data and a set of operations enabled for the data based on the identifier of the data. In an example, the data structure is populated from the service definition. In an example, the operations of the method 500 further include communicating with the trusted service in response to receiving the request. In an example, where the hardware vault device is a chiplet in a chiplet system, the trusted service is implemented with a trusted execution environment (TEE) in the chiplet system. In an example, the trusted service is a host external to the chiplet system.

At operation 530, an encrypted form of the data is read (e.g., by the processing circuitry) from a location based on the reference. In an example, the location is in a second data structure, and wherein the processing circuitry queries the second data structure using the reference as a key to obtain the location.

At operation 540, the data is decrypted (e.g., by the processing circuitry) from the encrypted form.

At operation 550, the operation is executed (e.g., by the processing circuitry) on the data to produce a result. In an example, wherein the request includes a writeback location, executing the operation includes retrieving second data from the writeback location, and using the second data as a parameter to the operation, wherein the result is a modification of the second data. In an example, the second data is a portion of a neural network. In an example, the operation is a training operation for the neural network. In an example, the result is an update to the portion of the neural network.

At operation 560, the result is written to a writeback location. In an example, writing the result to the writeback location includes writing the result to a set of output registers of the hardware vault device. In an example, writing the result includes transmitting the result via the interface. In an example, the interface conforms to a Compute Express Link (CXL) family of standards. In an example, wherein the result is encrypted with the key before writing to the writeback location is complete.

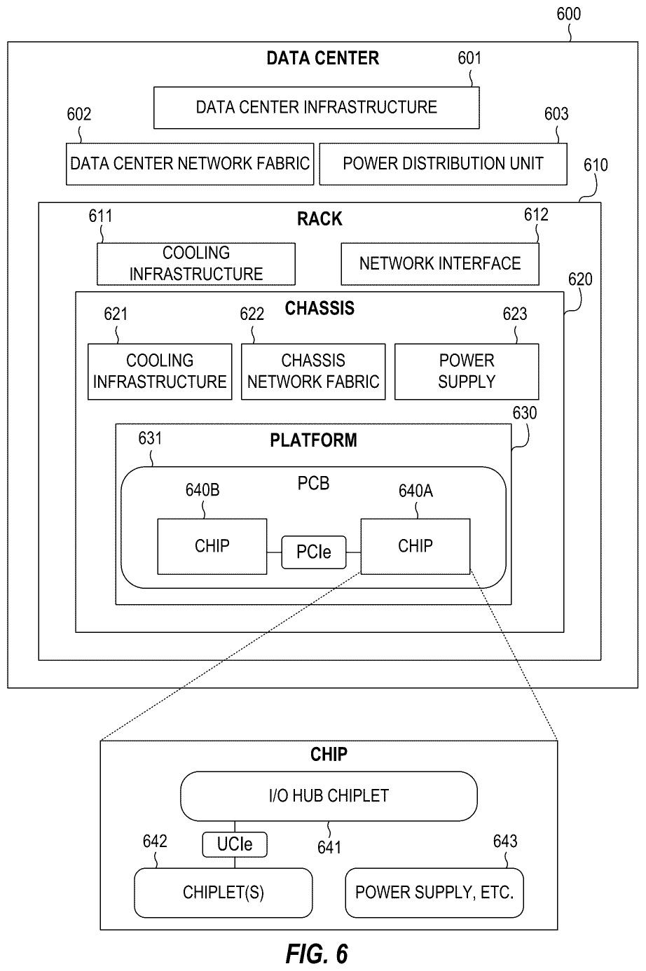

FIGS. 6, 7A, 7B, and 8 respectively depict simplified aspects of example computing architectures in which any of the techniques and configurations above may be implemented. It will be understood that the elements described above for hardware enforced data isolation may be integrated into various forms of the following hardware components.

FIG. 6 depicts an example hardware arrangement of a data center 600 used to provide multiple implementations or instances of a computing system (e.g., computing system 800, discussed below), with each instance of the computing system being identified as a respective platform (e.g., platform 630). The data center 600 includes data center infrastructure 601, a data center network fabric 602, and a power distribution unit 603 to support multiple racks of compute platforms, with a single instance of a rack 610 depicted. The data center infrastructure 601 may provide physical components that host the compute platform hardware, storage components, and networking equipment; the data center network fabric 602 may include switches and networking components to support data flows among various compute platforms and storage devices throughout the data center; and the power distribution unit 603 may include components to distribute and control power among the various compute platforms, networking, and storage devices.

The rack 610 includes but is not limited to cooling infrastructure 611, a network interface 612, and related physical components (not shown) to support discrete instances of multiple chassis. The rack 610 provides power, connectivity, and cooling to each of the multiple chassis in a single rack, with a single instance of a chassis 620 depicted in FIG. 6. The chassis 620 includes but is not limited to cooling infrastructure 621, a chassis network fabric 622, and a power supply 623, which provides cooling, network connectivity, and power to multiple platforms within the chassis, with a single instance of a platform 630 depicted in FIG. 6. It will be understood that a common data center rack configuration may include dozens of chassis, with each chassis adapted to support a number of platforms depending on the physical size of the platform hardware and supporting equipment.

The platform 630 in some implementations may be referred to as a server or node, depending on the use case for the platform 630 and the data center 600. The platform 630 includes but is not limited to implementations of a discrete computing system hosted on a single board. The platform 630 is depicted as hosting a chip assembly 640A and chip assembly 640B on a first board provided by a printed circuitry board (PCB) or other platform board, shown as PCB 631. In some examples, the platform 630 may include only one chip package, whereas the PCB 631 depicts interconnection of multiple chip assemblies via a device-to-device interface (e.g., a PCI express (PCIe) or compute express link (CXL) interface). Additional chip packages and components (not shown) may also be hosted on the PCB 631.

Some implementations of the chip assembly 640A and 640B may be termed as a System-on-Chip (SoC) package, as modular chiplets that perform different functions are integrated into a single package-even though this chip package is composed of multiple dies unlike a traditional SoC design that uses a single die. Other implementations of the chip assembly 640A and 640B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 640A and chip assembly 640B are each packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of chip assembly 640A is depicted as including a I/O Hub chiplet 641, chiplets 642, and a power supply 643. These components may be hosted on an interposer that is designed to connect multiple dies or components within a single semiconductor package (e.g., chip package). In some examples, the chiplets 642 may be manufactured and sourced separately and later assembled into the chip package to create the chip assembly 640A. Various connections may be provided among the chiplets 642 such as with the use of Universal Chiplet Interconnect Express (UCle) or similar chiplet-to-chiplet interfaces and interconnects (e.g. Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced extensible Interface (AXI), and certain implementations of PCIe, CXL, etc.).

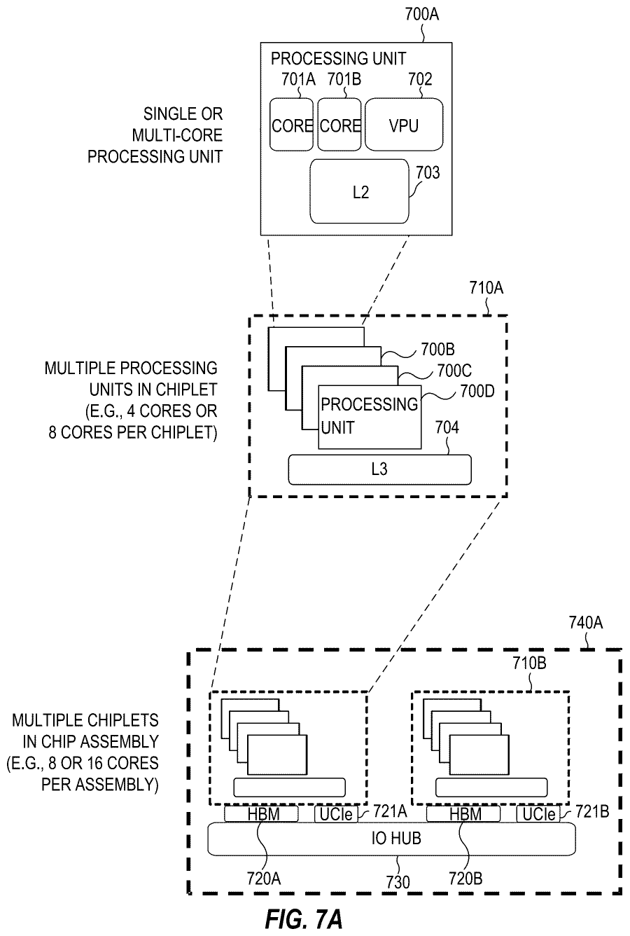

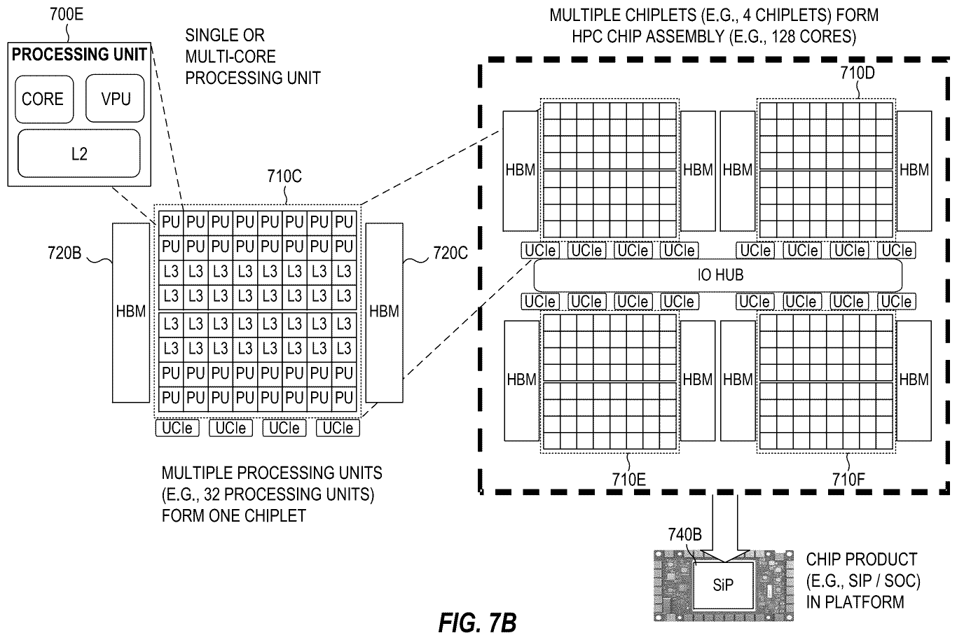

FIG. 7A depicts an example arrangement of a chip assembly 740A (e.g., a multi-processing core implementation of chip assembly 640A or 640B), with expanded views of the chiplets and processing units included therein. This arrangement shows how the chip assembly 740A, which may constitute a SoC, SoP, SiP, or other type of chip package, is composed from chiplets such as chiplet 710A, chiplet 710B, etc. and associated on-package memory (e.g., high-speed memory) such as 3D-stacked, HBM instances shown as HBM 720A, HBM 720B, interfaces (e.g., UCle interfaces) shown as UCle 721A, UCle 721B, and I/O hub 730 (e.g., which may be implemented by a I/O chiplet). Other hardware elements of a chip package are not depicted for simplicity.

Each chiplet includes multiple processing units and each processing unit includes one or multiple cores. For instance, chiplet 710A as depicted includes four processing units (processing unit 700A, processing unit 700B, processing unit 700C, and processing unit 700D) and an L3 cache 704. Each processing unit may include one or multiple processing cores, one or multiple caches, and optionally other processing units or elements. For instance, processing unit 700A is depicted as including two cores (core 701A and core 701B), vector processing unit 702, and an L2 cache 703. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC) and packet switched communications, and the like.

FIG. 7B depicts an example arrangement of a chip assembly 740B (e.g., a multi-chiplet high-performance computing (HPC) implementation of chip assembly 640A, 640B), adapted for HPC applications (e.g., parallel processing operations involving thousands, millions, or more of processors or cores operating simultaneously). The example chip assembly 740B depicts placement as a SiP, SoC, or other package onto a platform board (e.g., PCB 631), and optionally in a data center (e.g., data center 600) or in a standalone deployment setting (e.g., in a standalone computer system, mobile computing device, autonomous device, etc.).

The chip assembly 740B is composed of multiple chiplets, shown with four chiplets, chiplet 710C, chiplet 710D, chiplet 710E, chiplet 710F. Each chiplet includes multiple processing units, such as 32 processing units with a corresponding L3 cache for each processing unit. Each processing unit may include one or multiple cores, such as a single-core processing unit 700E shown as part of chiplet 710C. The chip assembly 740B is also composed of corresponding memory resources, such as HBM elements corresponding to respective banks of processing units (e.g., HBM 720B and HBM 720C corresponding respective sets of processing units of chiplet 710C), UCle interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configure the computing system and implementing hardware (e.g., the processing unit 700, chiplet 710, chip 640, platform 630) to perform steps and operations described above for electronic systems or devices (e.g., to implement hardware enforced data isolation, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

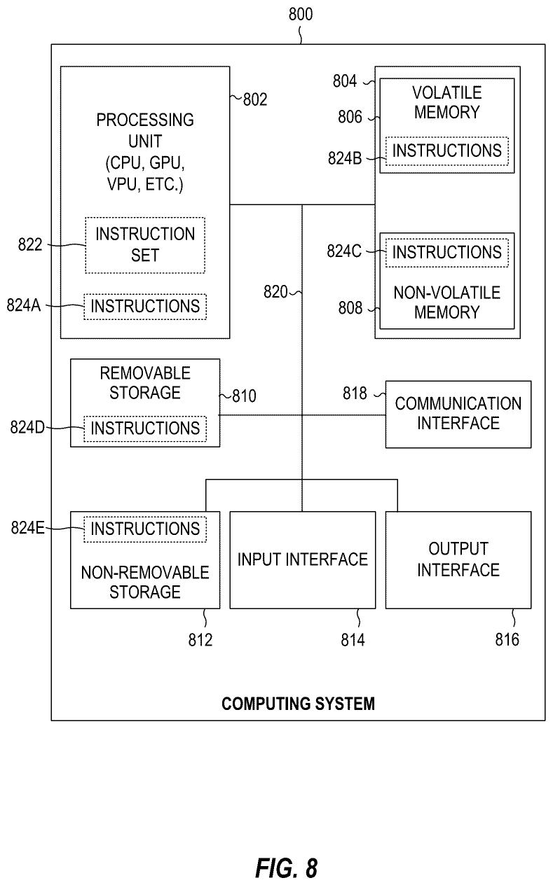

FIG. 8 depicts a block diagram of an example computing system 800 (e.g., device, apparatus, machine, etc.) that may be programmed into a special purpose machine suitable for implementing one or more embodiments for hardware enforced data isolation and like aspects disclosed herein. For instance, the components or sub-components described above may be embodied by the computing system 800, such as in the form of a computer or specialized electronic device that includes sufficient processing power, memory resources, and communications throughput capability to perform operations consistent with the examples herein.

The computing system 800 may include at least one hardware processing unit 802 such as a central processing unit (CPU), a graphics processing unit (GPU), a vector processing unit (VPU), a neural processing unit (NPU), a hardware accelerator, or combinations or variants thereof. The at least one hardware processing unit 802 is an implementation of processor circuitry and may be embodied by various types of chip assemblies, products, or packages as discussed with reference to FIGS. 6 to 7B. Circuitry (e.g., processing circuitry) as used herein is a collection of circuits implemented in tangible entities of the computing system 800 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired).

In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 800 may also include at least one memory device 804 such as volatile memory 806 and non-volatile memory 808, and at least one storage device such as removable storage 810 and/or non-removable storage 812 such as a drive unit, some or all of which may communicate with each other via an interconnect, fabric, link, or bus 820.

The computing system 800 may include an output interface 816 such as an interface connected to a display device, and an input interface 814 such as an interface connected to an alphanumeric input device or a user interface (UI) navigation device. In some examples, a connected I/O device may also include a display device, alphanumeric input device, and navigation device that is integrated into a single unit such as a touch screen display.

The computing system 800 may additionally include a communication interface 818, such as for connection with a network interface device used to transmit and receive electronic signals on a network. The computing system 800 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices such as the volatile memory 806, the non-volatile memory 808, the removable storage 810, or the non-removable storage 812 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 824 with respective implementations of instructions 824A, 824B, 824C, 824D, and 824E.

The instructions 824 may reside, during execution or other operation of the computing system 800, completely or at least partially within the volatile memory 806 as instructions 824B, within non-volatile memory 808 as instructions 824C, within removable storage as instructions 824D, within non-removable storage as instructions 824E, or within the hardware processing unit 802 as instructions 824A. Thus, any combination of the hardware processing unit 802, the volatile memory 806, the non-volatile memory 808, or a storage device of the removable storage 810 or non-removable storage 812 may constitute a machine-readable medium or media. The instructions 824A, when loaded and executed by the hardware processing unit 802, may invoke or utilize a defined instruction set 822 of the hardware processing unit 802, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 802) discussed herein.

The term “machine readable medium” may include any medium that is capable of storing, encoding, or carrying instructions for execution by components or the whole of the computing system 800 (or a similar machine) and that cause the computing system 800 or its components to perform any one or more of the techniques or functions described herein, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 824 may further be transmitted or received over a communications network using a transmission medium via the communication interface 818 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, or devices, or related systems (including computer, robotic, and autonomous systems). The components of the illustrative devices, systems, and methods employed may be implemented in various examples by digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

Additional examples of the presently described embodiments include the following, non-limiting implementations. Each of the following non-limiting examples may stand on its own or may be combined in any permutation or combination with any one or more of the other examples provided below or throughout the present disclosure.

Example 1 is a hardware vault device for hardware enforced data isolation, the hardware vault device comprising: an interface; a memory; and processing circuitry that, when in operation, is configured to: receive, at the interface, a request to perform an operation on data, the request including a credential and a reference to the data; access a data structure in the memory for an indication that the operation is enabled for the data; read an encrypted form of the data from a location based on the reference; decrypt, based on the credential, the data from the encrypted form; execute the operation on the data to produce a result; and write the result to a writeback location.

In Example 2, the subject matter of Example 1, wherein the hardware vault device is a chiplet in a chiplet system.

In Example 3, the subject matter of Example 2, wherein the request originates from another chiplet in the chiplet system.

In Example 4, the subject matter of any of Examples 2-3, wherein the data is stored in the chiplet system and external to the hardware vault device.

In Example 5, the subject matter of any of Examples 2-4, wherein the data is stored external to the chiplet system.

In Example 6, the subject matter of any of Examples 1-5, wherein the request includes the writeback location.

In Example 7, the subject matter of Example 6, wherein, to execute the operation, the processing circuitry is configured to: retrieve second data from the writeback location; and use the second data as a parameter to the operation, wherein the result is a modification of the second data.

In Example 8, the subject matter of Example 7, wherein the second data is a portion of a neural network, wherein the operation is a training operation for the neural network, and wherein the result is an update to the portion of the neural network.

In Example 9, the subject matter of any of Examples 1-8, wherein, to write the result to the writeback location, the processing circuitry is configured to write the result to a set of output registers of the hardware vault device.

In Example 10, the subject matter of any of Examples 1-9, wherein, to write the result, the processing circuitry is configured to transmit the result via the interface.

In Example 11, the subject matter of Example 10, wherein the interface conforms to a Compute Express Link (CXL) family of standards.

In Example 12, the subject matter of any of Examples 1-11, wherein the request includes an application identifier, and wherein the indication that the operation is enabled for the data is based on a permission in a second data structure that is located based on the application identifier.

In Example 13, the subject matter of any of Examples 1-12, wherein the location is in a second data structure, and wherein the second data structure is queried using the reference as a key to obtain the location.

In Example 14, the subject matter of any of Examples 1-13, wherein the reference is an address for the data.

In Example 15, the subject matter of any of Examples 1-14, wherein the data is stored in storage of the hardware vault device.

In Example 16, the subject matter of any of Examples 1-15, wherein the processing circuitry is configured to receive a service definition from a trusted service external to the hardware vault device, the service definition including an identifier of the data and a set of operations enabled for the data based on the identifier of the data, the data structure populated based on the service definition.

In Example 17, the subject matter of Example 16, wherein the processing circuitry is configured to communicate with the trusted service in response to receiving the request.

In Example 18, the subject matter of any of Examples 16-17, wherein the hardware vault device is a chiplet in a chiplet system, and wherein the trusted service is implemented with a trusted execution environment (TEE) in the chiplet system.

In Example 19, the subject matter of any of Examples 16-18, wherein the hardware vault device is a chiplet in a chiplet system, wherein the trusted service is a host external to the chiplet system.

In Example 20, the subject matter of any of Examples 1-19, wherein the result is encrypted with a key before writing to the writeback location is complete, wherein the key is based on the credential.

Example 21 is a method for hardware enforced data isolation, the method comprising: receiving, at an interface of a hardware vault device, a request to perform an operation on data, the request including a credential and a reference to the data; accessing, by processing circuitry of the hardware vault device, a data structure for an indication that the operation is enabled for the data; reading, by the processing circuitry, an encrypted form of the data from a location based on the reference; decrypting, by the processing circuitry and based on the credential, the data from the encrypted form; executing, by the processing circuitry, the operation on the data to produce a result; and writing the result to a writeback location.

In Example 22, the subject matter of Example 21, wherein the hardware vault device is a chiplet in a chiplet system.

In Example 23, the subject matter of Example 22, wherein the request originates from another chiplet in the chiplet system.

In Example 24, the subject matter of any of Examples 22-23, wherein the data is stored in the chiplet system and external to the hardware vault device.

In Example 25, the subject matter of any of Examples 22-24, wherein the data is stored external to the chiplet system.

In Example 26, the subject matter of any of Examples 21-25, wherein the request includes the writeback location.

In Example 27, the subject matter of Example 26, wherein executing the operation includes the processing circuitry: retrieving second data from the writeback location; and using the second data as a parameter to the operation, wherein the result is a modification of the second data.

In Example 28, the subject matter of Example 27, wherein the second data is a portion of a neural network, wherein the operation is a training operation for the neural network, and wherein the result is an update to the portion of the neural network.

In Example 29, the subject matter of any of Examples 21-28, wherein writing the result to the writeback location includes writing the result to a set of output registers of the hardware vault device.

In Example 30, the subject matter of any of Examples 21-29, wherein writing the result includes transmitting the result via the interface.

In Example 31, the subject matter of Example 30, wherein the interface conforms to a Compute Express Link (CXL) family of standards.

In Example 32, the subject matter of any of Examples 21-31, wherein the request includes an application identifier, and wherein the indication that the operation is enabled for the data is based on a permission in a second data structure that is located based on the application identifier.

In Example 33, the subject matter of any of Examples 21-32, wherein the location is in a second data structure, and wherein the processing circuitry queries the second data structure using the reference as a key to obtain the location.

In Example 34, the subject matter of any of Examples 21-33, wherein the reference is an address for the data.

In Example 35, the subject matter of any of Examples 21-34, wherein the data is stored in storage of the hardware vault device.

In Example 36, the subject matter of any of Examples 21-35, comprising receiving a service definition from a trusted service external to the hardware vault device, the service definition including an identifier of the data and a set of operations enabled for the data based on the identifier of the data, the data structure populated based on the service definition.

In Example 37, the subject matter of Example 36, comprising communicating with the trusted service in response to receiving the request.

In Example 38, the subject matter of any of Examples 36-37, wherein the hardware vault device is a chiplet in a chiplet system, and wherein the trusted service is implemented with a trusted execution environment (TEE) in the chiplet system.

In Example 39, the subject matter of any of Examples 36-38, wherein the hardware vault device is a chiplet in a chiplet system, wherein the trusted service is a host external to the chiplet system.

In Example 40, the subject matter of any of Examples 21-39, wherein the result is encrypted with a key before writing to the writeback location is complete, wherein the key is based on the credential.

Example 41 is machine readable media including instructions for hardware enforced data isolation, the instructions, when executed by processing circuitry of a hardware vault device, cause the processing circuitry to perform operations comprising: receiving, at an interface of the hardware vault device, a request to perform an operation on data, the request including a credential and a reference to the data; accessing a data structure for an indication that the operation is enabled for the data; reading an encrypted form of the data from a location based on the reference; decrypting, based on the credential, the data from the encrypted form; executing the operation on the data to produce a result; and writing the result to a writeback location.

In Example 42, the subject matter of Example 41, wherein the hardware vault device is a chiplet in a chiplet system.

In Example 43, the subject matter of Example 42, wherein the request originates from another chiplet in the chiplet system.

In Example 44, the subject matter of any of Examples 42-43, wherein the data is stored in the chiplet system and external to the hardware vault device.

In Example 45, the subject matter of any of Examples 42-44, wherein the data is stored external to the chiplet system.

In Example 46, the subject matter of any of Examples 41-45, wherein the request includes the writeback location.

In Example 47, the subject matter of Example 46, wherein executing the operation includes: retrieving second data from the writeback location; and using the second data as a parameter to the operation, wherein the result is a modification of the second data.

In Example 48, the subject matter of Example 47, wherein the second data is a portion of a neural network, wherein the operation is a training operation for the neural network, and wherein the result is an update to the portion of the neural network.

In Example 49, the subject matter of any of Examples 41-48, wherein writing the result to the writeback location includes writing the result to a set of output registers of the hardware vault device.

In Example 50, the subject matter of any of Examples 41-49, wherein writing the result includes transmitting the result via the interface.

In Example 51, the subject matter of Example 50, wherein the interface conforms to a Compute Express Link (CXL) family of standards.

In Example 52, the subject matter of any of Examples 41-51, wherein the request includes an application identifier, and wherein the indication that the operation is enabled for the data is based on a permission in a second data structure that is located based on the application identifier.

In Example 53, the subject matter of any of Examples 41-52, wherein the location is in a second data structure, and wherein the second data structure is queried using the reference as a key to obtain the location.

In Example 54, the subject matter of any of Examples 41-53, wherein the reference is an address for the data.

In Example 55, the subject matter of any of Examples 41-54, wherein the data is stored in storage of the hardware vault device.

In Example 56, the subject matter of any of Examples 41-55, wherein the operations comprise receiving a service definition from a trusted service external to the hardware vault device, the service definition including an identifier of the data and a set of operations enabled for the data based on the identifier of the data, the data structure populated based on the service definition.

In Example 57, the subject matter of Example 56, wherein the operations comprise communicating with the trusted service in response to receiving the request.

In Example 58, the subject matter of any of Examples 56-57, wherein the hardware vault device is a chiplet in a chiplet system, and wherein the trusted service is implemented with a trusted execution environment (TEE) in the chiplet system.

In Example 59, the subject matter of any of Examples 56-58, wherein the hardware vault device is a chiplet in a chiplet system, wherein the trusted service is a host external to the chiplet system.

In Example 60, the subject matter of any of Examples 41-59, wherein the result is encrypted with a key before writing to the writeback location is complete, wherein the key is based on the credential.

Example 61 is a system for hardware enforced data isolation, the system comprising: means for receiving, at an interface of a hardware vault device, a request to perform an operation on data, the request including a credential and a reference to the data; means for accessing, by the hardware vault device, a data structure for an indication that the operation is enabled for the data; means for reading an encrypted form of the data from a location based on the reference; means for decrypting, based on the credential, the data from the encrypted form; means for executing the operation on the data to produce a result; and means for writing the result to a writeback location.

In Example 62, the subject matter of Example 61, wherein the hardware vault device is a chiplet in a chiplet system.

In Example 63, the subject matter of Example 62, wherein the request originates from another chiplet in the chiplet system.

In Example 64, the subject matter of any of Examples 62-63, wherein the data is stored in the chiplet system and external to the hardware vault device.

In Example 65, the subject matter of any of Examples 62-64, wherein the data is stored external to the chiplet system.

In Example 66, the subject matter of any of Examples 61-65, wherein the request includes the writeback location.

In Example 67, the subject matter of Example 66, wherein the means for executing the operation include means for: retrieving second data from the writeback location; and using the second data as a parameter to the operation, wherein the result is a modification of the second data.

In Example 68, the subject matter of Example 67, wherein the second data is a portion of a neural network, wherein the operation is a training operation for the neural network, and wherein the result is an update to the portion of the neural network.

In Example 69, the subject matter of any of Examples 61-68, wherein the means for writing the result to the writeback location include means for writing the result to a set of output registers of the hardware vault device.

In Example 70, the subject matter of any of Examples 61-69, wherein the means for writing the result include means for transmitting the result via the interface.

In Example 71, the subject matter of Example 70, wherein the interface conforms to a Compute Express Link (CXL) family of standards.

In Example 72, the subject matter of any of Examples 61-71, wherein the request includes an application identifier, and wherein the indication that the operation is enabled for the data is based on a permission in a second data structure that is located based on the application identifier.

In Example 73, the subject matter of any of Examples 61-72, wherein the location is in a second data structure, and wherein the second data structure is queried using the reference as a key to obtain the location.

In Example 74, the subject matter of any of Examples 61-73, wherein the reference is an address for the data.

In Example 75, the subject matter of any of Examples 61-74, wherein the data is stored in storage of the hardware vault device.

In Example 76, the subject matter of any of Examples 61-75, comprising means for receiving a service definition from a trusted service external to the hardware vault device, the service definition including an identifier of the data and a set of operations enabled for the data based on the identifier of the data, the data structure populated based on the service definition.

In Example 77, the subject matter of Example 76, comprising means for communicating with the trusted service in response to receiving the request.

In Example 78, the subject matter of any of Examples 76-77, wherein the hardware vault device is a chiplet in a chiplet system, and wherein the trusted service is implemented with a trusted execution environment (TEE) in the chiplet system.

In Example 79, the subject matter of any of Examples 76-78, wherein the hardware vault device is a chiplet in a chiplet system, wherein the trusted service is a host external to the chiplet system.

In Example 80, the subject matter of any of Examples 61-79, wherein the result is encrypted with a key before writing to the writeback location is complete, wherein the key is based on the credential.

Example 81 is at least one machine-readable medium including instructions that, when executed by processing circuitry, cause the processing circuitry to perform operations to implement any of Examples 1-80.

Example 82 is an apparatus comprising means to implement any of Examples 1-80.

Example 83 is a system to implement any of Examples 1-80.

Example 84 is a method to implement any of Examples 1-80.

What is claimed is:

1. A device for hardware enforced data isolation, the device comprising:
an interface;
a memory; and
processing circuitry that, when in operation, is configured to:
receive, at the interface, a request to perform an operation on data, the request including a credential and a reference to the data;
access a data structure in the memory for an indication that the operation is enabled for the data;
read an encrypted form of the data from a location based on the reference;
decrypt, based on the credential, the data from the encrypted form;
execute the operation on the data to produce a result; and
write the result to a writeback location.

2. The device of claim 1, wherein the device is a chiplet in a chiplet system.

3. The device of claim 1, wherein the request includes the writeback location.

4. The device of claim 1, wherein, to write the result to the writeback location, the processing circuitry is configured to write the result to a set of output registers of the device.

5. The device of claim 1, wherein, to write the result, the processing circuitry is configured to transmit the result via the interface.

6. The device of claim 1, wherein the request includes an application identifier, and wherein the indication that the operation is enabled for the data is based on a permission in a second data structure that is located based on the application identifier.

7. The device of claim 1, wherein the location is in a second data structure, and wherein the second data structure is queried using the reference as a key to obtain the location.

8. The device of claim 1, wherein the reference is an address for the data.

9. The device of claim 1, wherein the processing circuitry is configured to receive a service definition from a trusted service external to the device, the service definition including an identifier of the data and a set of operations enabled for the data based on the identifier of the data, the data structure populated based on the service definition.

10. The device of claim 1, wherein the result is encrypted with a key before writing to the writeback location is complete, wherein the key is based on the credential.

11. Non-transitory machine readable media including instructions for hardware enforced data isolation, the instructions, when executed by processing circuitry of a device, cause the processing circuitry to perform operations comprising:
receiving, at an interface of the device, a request to perform an operation on data, the request including a credential and a reference to the data;
accessing a data structure for an indication that the operation is enabled for the data;
reading an encrypted form of the data from a location based on the reference;
decrypting, based on the credential, the data from the encrypted form;
executing the operation on the data to produce a result; and
writing the result to a writeback location.

12. The non-transitory machine readable media of claim 11, wherein the device is a chiplet in a chiplet system.

13. The non-transitory machine readable media of claim 11, wherein the request includes the writeback location.

14. The non-transitory machine readable media of claim 11, wherein writing the result to the writeback location includes writing the result to a set of output registers of the device.

15. The non-transitory machine readable media of claim 11, wherein writing the result includes transmitting the result via the interface.

16. The non-transitory machine readable media of claim 11, wherein the request includes an application identifier, and wherein the indication that the operation is enabled for the data is based on a permission in a second data structure that is located based on the application identifier.

17. The non-transitory machine readable media of claim 11, wherein the location is in a second data structure, and wherein the second data structure is queried using the reference as a key to obtain the location.

18. The non-transitory machine readable media of claim 11, wherein the reference is an address for the data.

19. The non-transitory machine readable media of claim 11, wherein the operations comprise receiving a service definition from a trusted service external to the device, the service definition including an identifier of the data and a set of operations enabled for the data based on the identifier of the data, the data structure populated based on the service definition.

20. The non-transitory machine readable media of claim 11, wherein the result is encrypted with a key before writing to the writeback location is complete, wherein the key is based on the credential.
